(19) United States
(12) Patent Application Publication
(10) Pub. No.: US 2005/0243809 A1
(43) Pub. Date: Nov. 3, 2005

(54) System and method for configuration of Cisco's callmanager VoIP telephony

(75) Inventors: James Floyd Best, Trophy Club, TX (US); Chris Rajczi, Allen, TX (US)

Correspondence Address: SCULLY SCOTT MURPHY & PRESSER, PC, 400 GARDEN CITY PLAZA, SUITE 300, GARDEN CITY, NY, 11530, US

(73) Assignee: NEC America, Inc., Melville, NY (US)

(21) Appl. No.: 10/833,544

(22) Filed: Apr. 28, 2004

(51) Int. Cl. H04L 12/66

(52) U.S. Cl. 370/356

(57) ABSTRACT

There is provided a method and system for deploying a VoIP telephone system to a location, the VoIP telephone system including a server for managing communication to and from one or more VoIP telephones via a network, comprising: collecting information associated with a dial plan for a plurality of users for location and updating the dial plan; automatically generating a plurality of output data files comprising data from the dial plan, each output data file being generated for each unique combination of VoIP telephone type, number of extensions per VoIP telephone and calling search space for the location; and configuring the server of the VoIP system via each unique output data file.

### BACKGROUND OF THE INVENTION

1. Technical Field of the Invention

The present invention generally relates to improvements for Cicso's CallManager voice-over-IP (VoIP) telephony. More specifically, the present invention is directed to a system and method for improved configuration of Cisco's CallManager VoIP telephony and for streamlining the deployment process thereof at an enterprise.

2. Description of the Prior Art

FIG. 1 depicts Cisco's CallManager VoIP telephony system 100 for an enterprise. In the system 100, there are depicted a publisher server 102, a subscriber server 104 and three VoIP telephones 108a-108c, which are all interconnected via a network 106. The communication over the network 106 is accomplished via Transfer Control Protocol/Internet Protocol (i.e., “TCP/IP”). Although not depicted, the network 106 is connected to an IP-based Wide Area Network (WAN), such as the Internet. The publisher server 102 is a minimally required server in the system 100, which serves as a primary CallManger server that supports the VoIP telephony system 100. More specifically, the publisher server 102 is designated as a main structured query language (SQL) server, which stores an SQL database (not shown). The publisher server 102 reads and writes the SQL database, which stores configuration details, call detail records and parameters that are defined for the enterprise. The subscriber server 104 serves as a secondary CallManager server that supports the VoIP telephony system 100 if the publisher server 102 (i.e., the primary CallManager server) were to fail. However, the VoIP telephones 108a-108c consider the subscriber server 104 as their main call processor server for VoIP calls via system 100. The VoIP telephones 108a-108c register with the subscriber server 104 to be able to make and receive VoIP calls. It is noted that each of VoIP telephones 108a-108c comprises an associated media access control (i.e., “MAC”) address, which represents a unique physical address on the network 106. Dial plans in the publisher server 102 for the VoIP telephone are configured via Cisco's Bulk Administration Tool.

Cisco's Bulk Administration Tool presently utilizes a Microsoft Excel Spreadsheet that imports a comma-delimited (or comma-separated value—“CSV”) file to configure the dials plans in the publisher server 102 for the VoIP telephony by the enterprise. However, the Microsoft Excel Spreadsheet does not assure uniqueness of an extension for a VoIP telephone or the VoIP telephone's MAC address assignment in the CSV file. The Microsoft Excel Spreadsheet does not consider the VoIP telephone's serial number/bar code in its processing of the VoIP telephones. Furthermore, the Microsoft Excel Spreadsheet does not provide a mechanism for indicating the physical placement of VoIP telephone within the enterprise.

Therefore there is a need in the art for providing a system and method for the improved configuration of Cisco's CallManager VoIP telephony and streamlined deployment thereof at the enterprise.

### SUMMARY OF THE INVENTION

It is an object of the present invention to provide a system and method for improved configuration of Cisco's CallManager VoIP telephony and for streamlining the deployment process thereof at the enterprise.

According to an embodiment of the present invention, there is provided a method for deploying a VoIP telephone system to a location, the VoIP telephone system including a server for managing communication to and from one or more VoIP telephones via a network, the method comprising the step of: (a) collecting information associated with a dial plan for a plurality of users for a location and updating the dial plan; (b) automatically generating a plurality of output data files comprising data from the dial plan, each output data file being generated for each unique combination of VoIP telephone type, number of extensions per VoIP telephone and calling search space for the location; and (c) configuring the server of the VoIP telephone system via each unique output data file.

According to another embodiment of the present invention, there is provided a system for deploying a VoIP telephone system to a location, the VoIP telephone system including a server for managing communication to and from one or more VoIP telephones via a network, the system comprising: a dial plan server for storing a dial plan; a client for (i) collecting information associated with a dial plan for the plurality of users for a location and updating the dial plan at the dial plan server; and (ii) automatically generating a plurality of output data files comprising data from the dial plan, each output data file being generated for each unique combination of VoIP telephone type, number of extensions per VoIP telephone and calling search space for the location, wherein the server of the VoIP telephone system is configured via each unique output data file generated by the client.

### BRIEF DESCRIPTION OF THE DRAWINGS

The features and advantages of the present invention will become apparent to one skilled in the art, in view of the following detailed description taken in combination with the attached drawings, in which:

FIG. 1 illustrates a prior art Cicso CallManager voice-over-IP (VoIP) telephony system for an enterprise;

FIG. 2 illustrates a startup screen display when the Dial Plan Genie (DPG) software application is launched by a user, according to the present invention;

FIG. 3 illustrates a screen display for querying the user regarding the user's role in using the DPG software application, according to the present invention;

FIG. 4 illustrates a main screen display in the DPG software application, according to the present invention;

FIG. 5 illustrates a drilled down screen display of clients (customers) area illustrated in FIG. 4, according to the present invention;

FIG. 6 illustrate a drilled down screen display for the sites (publishers) area illustrated in FIG. 4, according to the present invention;

FIG. 7 illustrate a drilled down screen display for the setup area illustrated in FIG. 4, according to the present invention;

FIG. 8 illustrates a client manager screen display for adding a new client (customer) illustrated in FIG. 5, according to the present invention;

FIG. 9 illustrates a dial plan screen display for editing a dial plan, according to the present invention;

FIG. 10 illustrates a site manger screen display for editing a site (publisher) without checkout lock, according to the present invention;

FIG. 11 illustrates a site manger screen display for editing a site (publisher) with checkout lock, according to the present invention.

FIG. 12 illustrates a MAC address entry screen display, according to the present invention;

FIG. 13 illustrates a phone label generated in FIG. 12, according to the present invention;

FIG. 14 illustrates a case label for a plurality of VoIP telephones generated in FIG. 12, according to the present invention;

FIG. 15 illustrates a portion of a sample dial plan report for a site for a client's signature, according to the present invention;

FIG. 15a illustrates a site definition report that details the parameters needed to be set within the Cisco's Bulk Administration Tool.

FIG. 16 illustrates a support information screen display for the DPG software application, according to the present invention.

FIG. 17 illustrates a logout screen display when the DPG software application is closed by a user, according to the present invention;

FIG. 18a-c illustrate CSV files generated by DPG software application for use by the Cisco's Bulk Administration Tool to configure the CallManager for voice-over-IP (VoIP) telephony for the enterprise, according to the present invention.

FIG. 19 illustrates field descriptions of a comma-separated-value (CSV) file, according to the present invention;

FIG. 20 illustrates a system and flow for the DPG software application, according to the present invention; and

FIG. 21 illustrates a support website for the DPG software application, according to the present invention.

### DETAILED DESCRIPTION OF THE PREFERRED EMBODIMENT OF THE INVENTION

The present invention is directed to a system and method for improving the configuration of Cisco's CallManager VoIP telephony and for streamlining the deployment process thereof at an enterprise. More specifically, the present invention provides a software application called the Dial Plan Genie (DPG), which facilitates the creation and management of dial plans for the enterprise and which facilitates the streamlined configuration of Cisco's CallManager VoIP telephony for the enterprise. Furthermore, the DPG facilitates the collection of user data, VoIP telephone and telephone type assignment to a user and the DPG further facilitates the placement or deployment process of VoIP telephones throughout the delivery process to the enterprise.

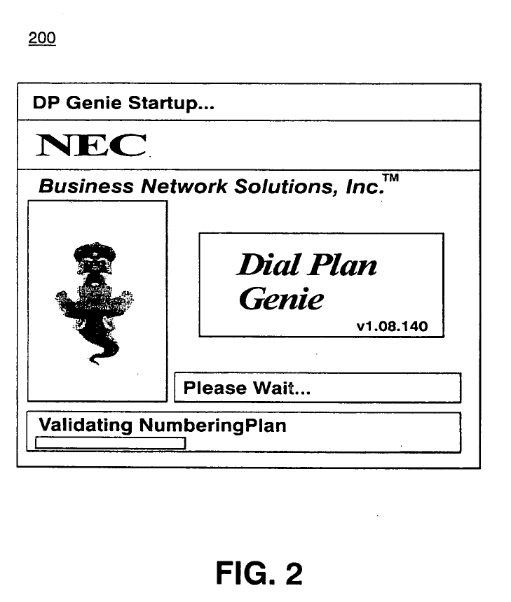

FIG. 2 is an exemplary illustration of a startup screen display 200 of the Dial Plan Genie (DPG) software application, according to the present invention. The screen display 200 is displayed on a display device of a personal computer (PC), e.g., a laptop, when the user executes the DPG software application. The DPG accesses a centralized data cache or a database (not shown), which is accessible to a plurality of authorized users as will be described below.

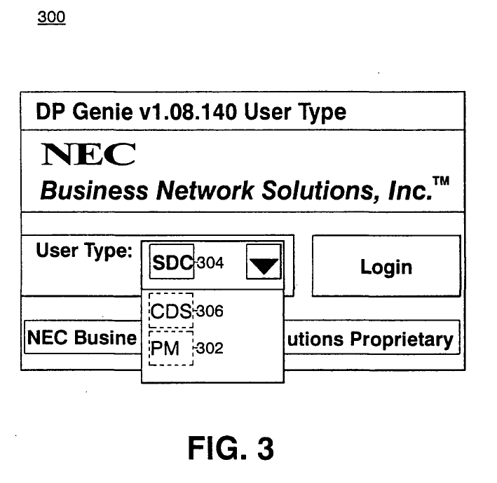

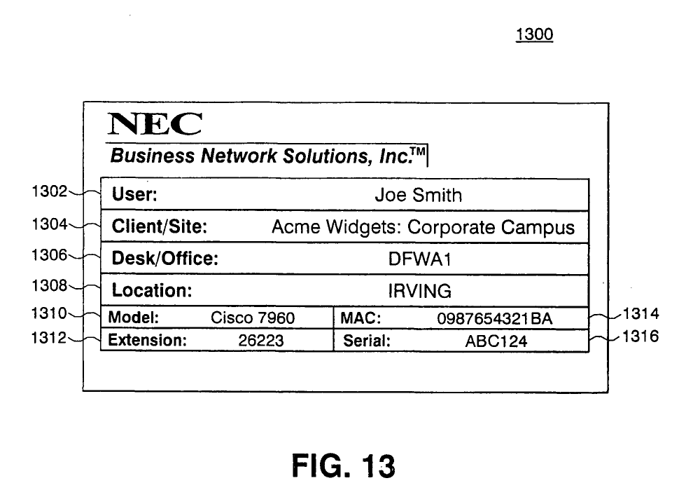

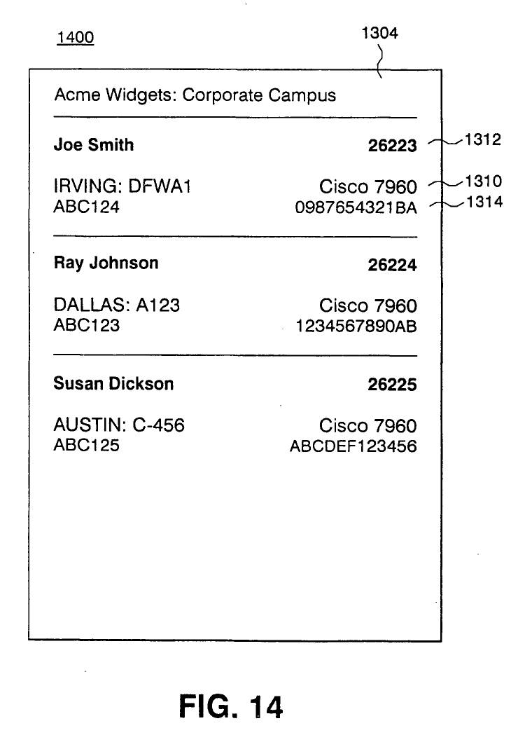

FIG. 3 is an exemplary illustration of a screen display 300 for querying the user regarding the user's role in using the DPG software application according to the present invention. More specifically, after validating the unique association between the user and a VoIP telephone stored in the data cache (database), the DPG prompts the user to identify the user's role for using the DPG software application and to login into the DPG. These roles are defined in Cisco's CallManager VoIP telephony for the enterprise. The roles identify what functions the users are authorized to perform while logged into the DPG software application. For example, the Project Manager (PM) 302 is authorized to create clients and sites, the Sales Design Consultant (SDC) 304 is authorized to build the dial plan and the Configuration and Deployment Services (CDS) engineer 306 is authorized to associate the VoIP telephones to the entries in the dial plan, generate telephone and case labels (depicted in FIGS. 13 and 14) for distribution in the Cisco's CallManager VoIP telephony for the enterprise.

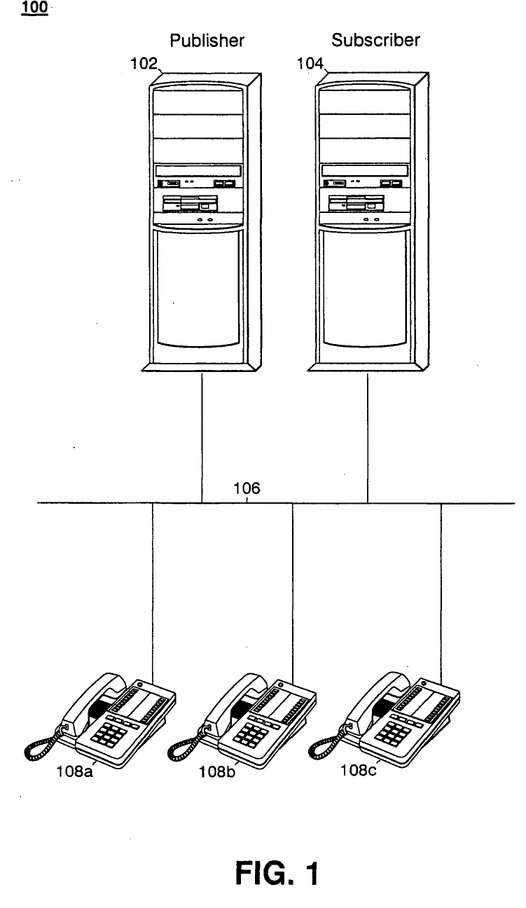

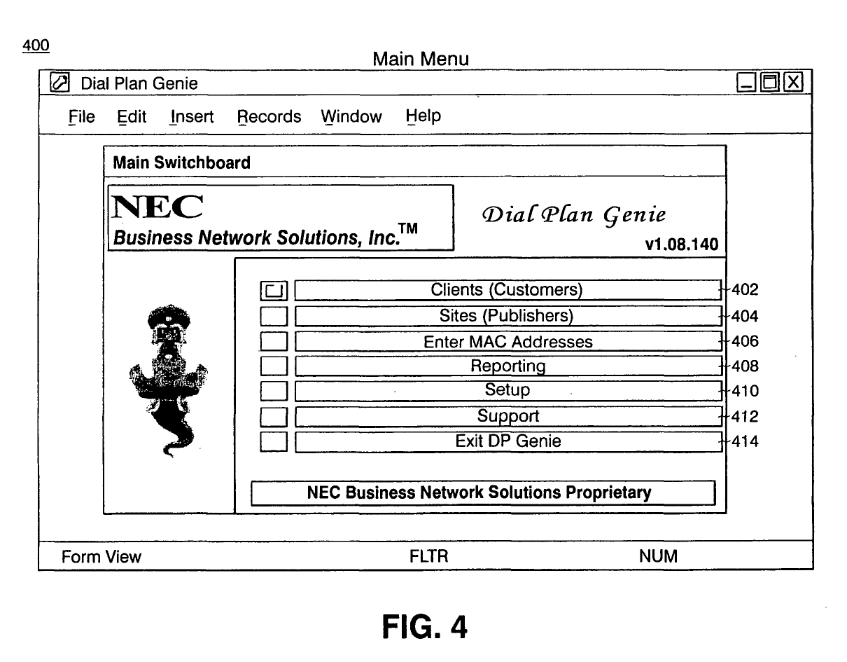

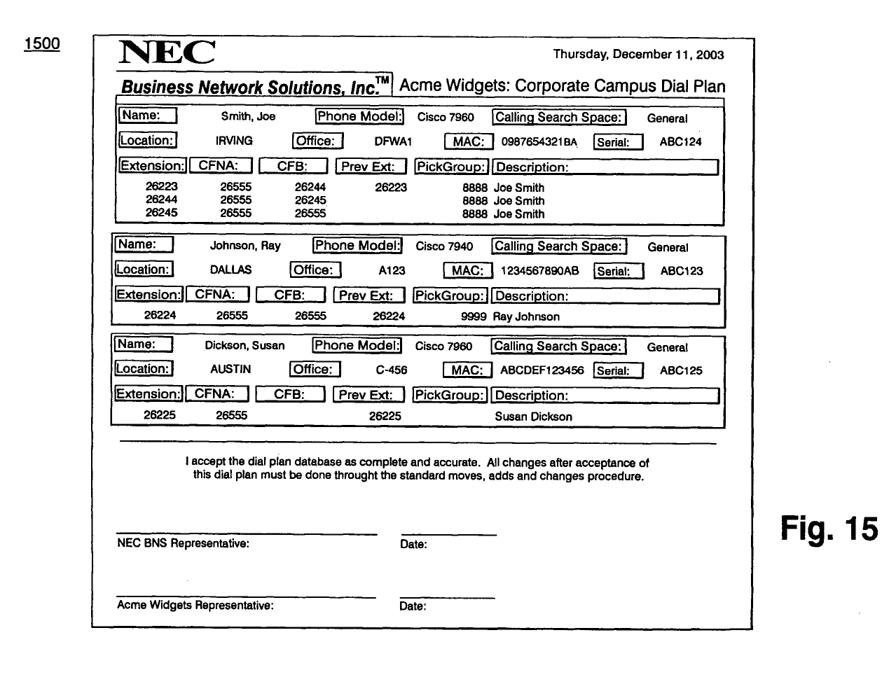

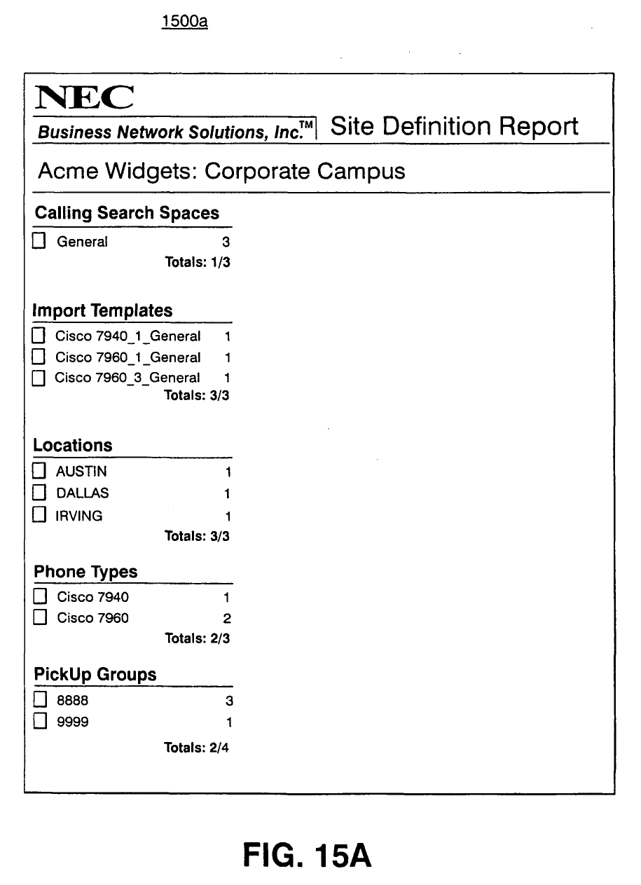

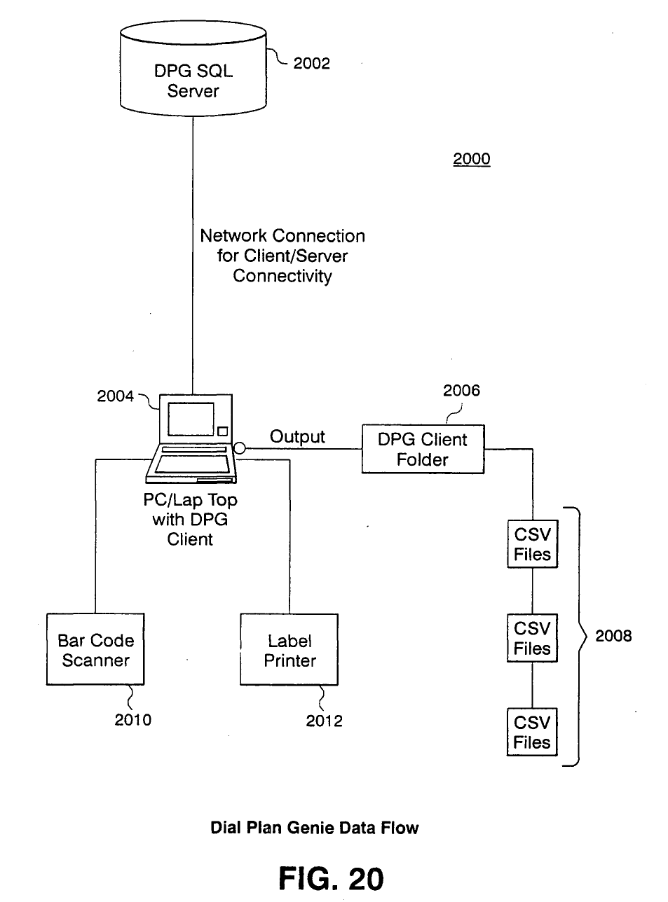

FIG. 4 is an exemplary illustration of a main screen display 400 in the DPG software application according to the present invention. More specifically, after logging into the DPG software application, an authorized and identified user is then presented with the main screen display for the DPG software application. From here the user can navigate to all other areas. The clients (customers) area 402 is for customers (e.g., an enterprise) for which a dial plan is being designed. For example, “NEC Business Network Solutions” would be a client or enterprise. The client or enterprise must be associated with at least one site (publisher) 404, for example the publisher server 102 depicted in FIG. 1. More specifically, the sites (publishers) are the specific Cisco's CallManager publisher servers that are to be used for the dial plan. Each site represents a specific CallManager cluster led by a publisher server. For example, there may be a site called “Building A, 2^{nd} floor” and a site called “Building B, 4^{th} floor.” Both of the sites may belong to the abovementioned “NEC Business Network Solutions” client or enterprise. The enter MAC addresses area 406 is where a CDS engineer would use a barcode scanner and a label printer to expedite the preparation of a CallManager for deployment, as particularly described hereinbelow with reference to FIGS. 13 and 20. The reporting area 408 is where dial plan and site directory reports can be generated. The dial plan report, described in detail hereinbelow in FIG. 15, details users and VoIP telephone parameters, including VoIP telephone extension, serial number, MAC address, office and location. The site directory provides a listing of VoIP telephone extensions and their user associations within the site or enterprise. The setup area 410 is where local application configuration settings are managed. The support area includes contact information for the application engineers to get updates and corrections for the DPG software application. The exit DPG software application area 414 closes the local secured database and logs off the DPG software application. The local secured database uses Access 2000. It is noted that the DPG software application connects to a central SQL2000 database (i.e., SQL server) server to update its information. The use of Access allows for the DPG software application to be used without a live network connection to the SQL server for the purposes of entering users, VoIP telephones and assignments.

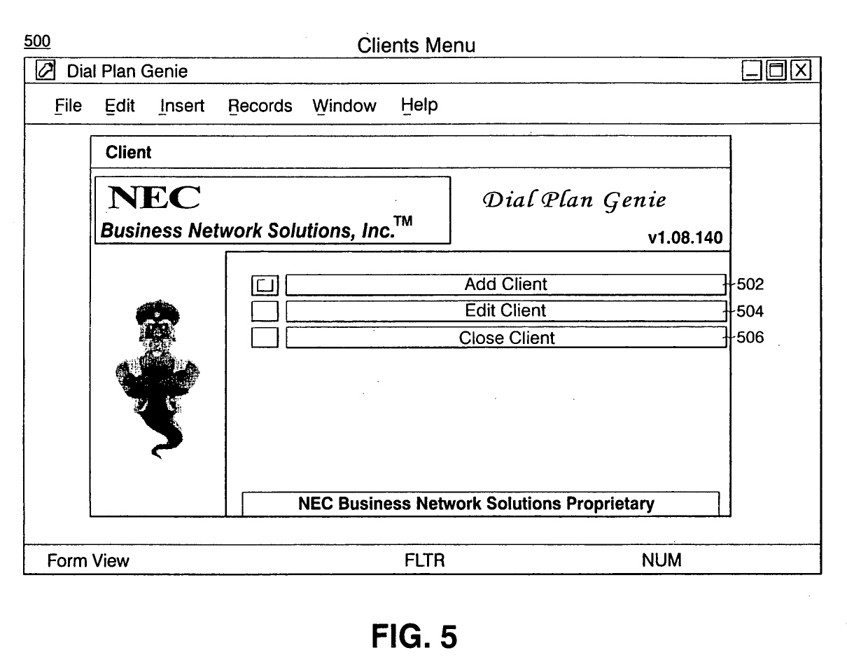

FIG. 5 is an exemplary illustration of as drilled down screen display for the clients (customers) area 402 illustrated in FIG. 4 according to the present invention. The authorized and identified user (i.e., project manager 302) may add a new client (customer) via 502, may edit an exiting client (customer) via 504 or close an existing client (customer) via 506. The close client 506 exits the DPG software application back to the main screen display 400.

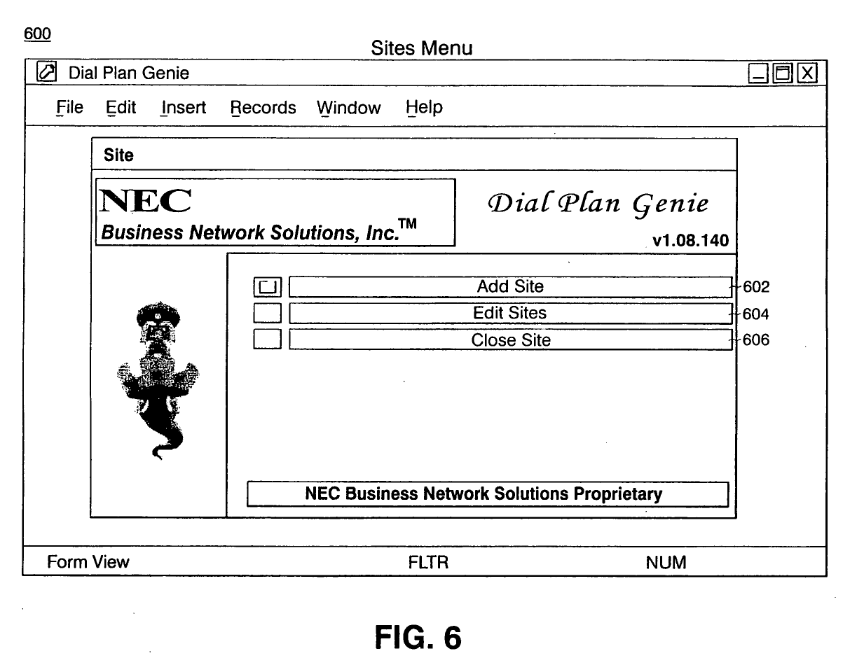

FIG. 6 is an exemplary illustration of as drilled down screen display for the sites (publishers) area 404 illustrated in FIG. 4 according to the present invention. The authorized and identified user (i.e., SDC) may add a new site (publisher) for the enterprise via 602, may edit an exiting site (publisher) for the enterprise via 604 or close an existing site (publisher) via 606.

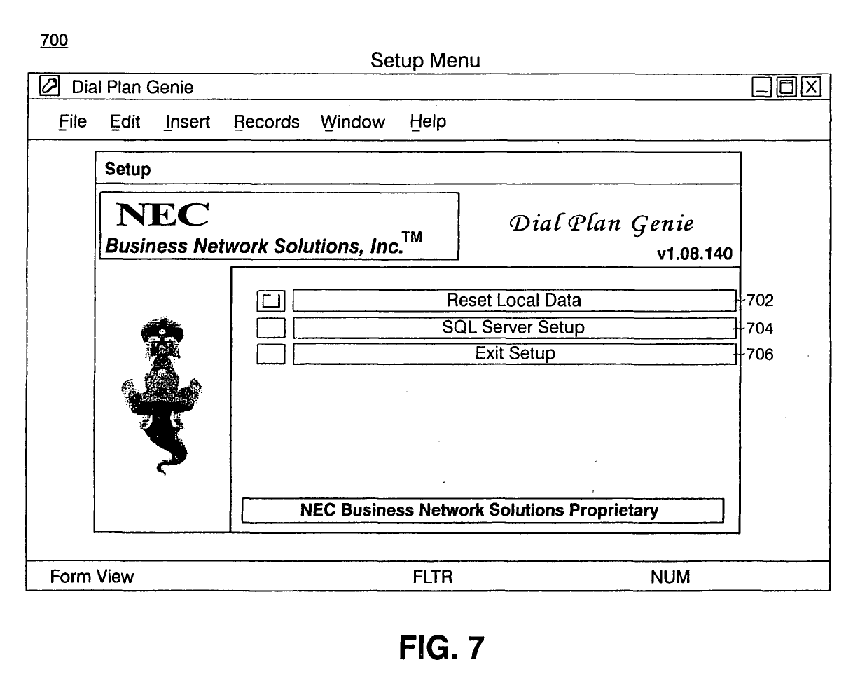

FIG. 7 is an exemplary illustration of as drilled down screen display for the setup area 410 illustrated in FIG. 4 according to the present invention. Any authorized and identified user (i.e., SDC, CDS or PM) may reset their local data in the local Access 2000 database via 702, may select the DPG SQL server via 704 or may exit setup are 410 via 706.

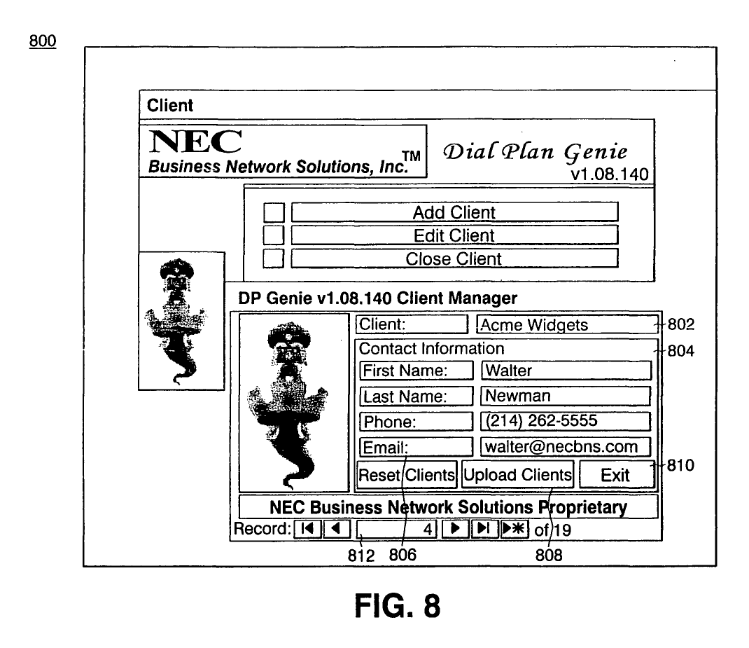

FIG. 8 is an exemplary illustration of client manager screen display for adding a new client (customer) 502 illustrated in FIG. 5 according to the present invention. The client manager allows a user (i.e., PM 302 or SDC 304) to create a new client within the DPG software system. A client name is assigned to the client at input field 802. The assigned client name is used in other areas of the DPG software application. Furthermore, contact information for the client is gathered via the plurality of contact information input fields 804. Contact information includes a contact name and some basic contact information, such as telephone number and email, which assist other users in knowing whom to contact for questions that are related to the new client. The client manager allows managing a plurality of clients. For example, the display at 812 identifies which new client is being currently displayed in the client manger screen display. The reset clients 806 enables a user to remove the locally cached client data and reload client data from the central DPG SQL server, should an incorrect client be added. More specifically, the reset clients 806 overwrites any client data previously entered into the DPG client with client data from the central SQL server, i.e., if client data is erroneously entered in the DPG client, the DPG client can be reset back to the client data available on the central SQL server. The upload clients 808 enables the user to upload a client that the user has just added to the DPG system to the central server to allow other users of the DPG software system to have access to the new client.

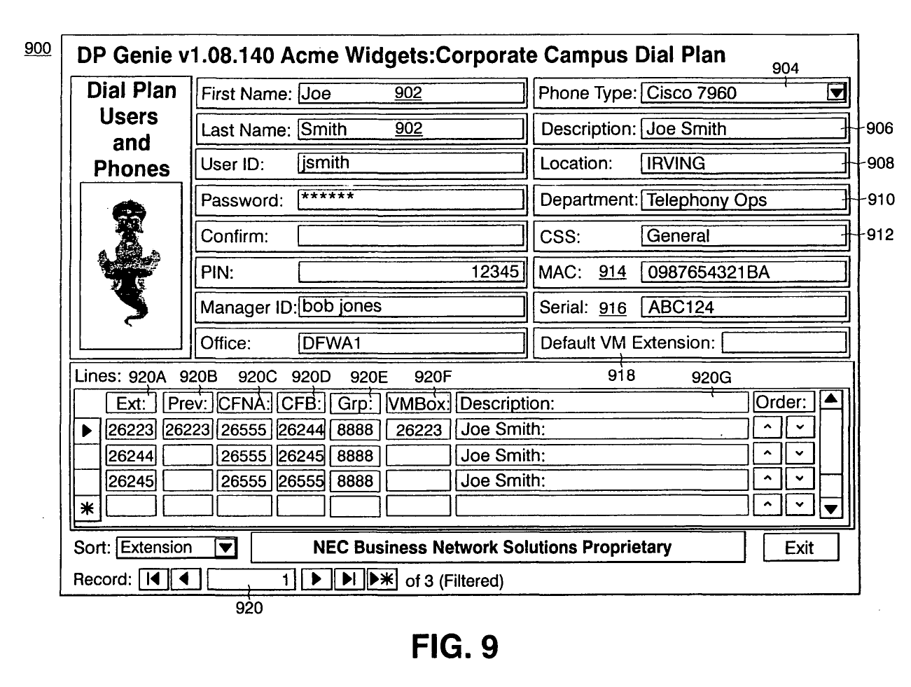

FIG. 9 is an exemplary illustration of a dial plan screen display for editing a dial plan according to the present invention. The dial plan screen display enable a SDC 304 user to define the calling plan for a given client 802 and given site for which they have acquired a checkout lock. The specifics about each VoIP telephone 108 can be inputted here. At input field 904, the phone type for telephone 108 is entered, e.g., Cisco 7940. At input field 906, the description of the telephone 108 is entered, i.e., a description of who is to use the telephone. At input field 910, the department to which the telephone 108 belongs is entered. A calling search space (CSS) for the telephone 108 is inputted at input field 912. The telephone's media access control (MAC) address is displayed at field 914. The MAC address 914 is a hardware address that uniquely identifies each VoIP telephone 108 on the network 106 in FIG. 1. The telephone's serial number used for warranty and maintenance tracking, is displayed at field 916. The SDC 304 cannot edit the fields 914 and 916 because it is the CDS 306 that performs these assignments. A default extension is assigned to the telephone at input field 918. Additional specifics can be input, such as user ID, password and the like.

Further with reference to FIG. 9, a specific record for a VoIP telephone/user being edited for a client is displayed at 920. Reference 920A is a primary extension or line appearance. The primary extension does not have to be unique to a particular VoIP telephone. That is, any extension may appear on any VoIP telephone. The DPG system will prompt a user (i.e., SDC) that an extension is already assigned as a warning in the event that this result is not desired. Reference 920B is an optional field used to indicate a user's previous extension with a new Cisco extension. This optional field is useful when performing migration and is included in the dial plan summary report. In addition, each telephone's call forwarding options (CFNA, CFB) may also be set. More specifically, reference 920C is set to indicate a call forward no answer (CFNA) extension, where if an extension does not answer the call is forwarded to the designated CFNA extension. Reference 920D is set to indicate call forward busy (CFB) extension, where if an extension does not answer because it is busy the call is forwarded to the CFB extension. Reference 920E is a call pickup group. Reference 920 F indicates the extension that is associated with a voicemail box. Lastly, description field 920G indicates the user's name that is carried does n from field 906.

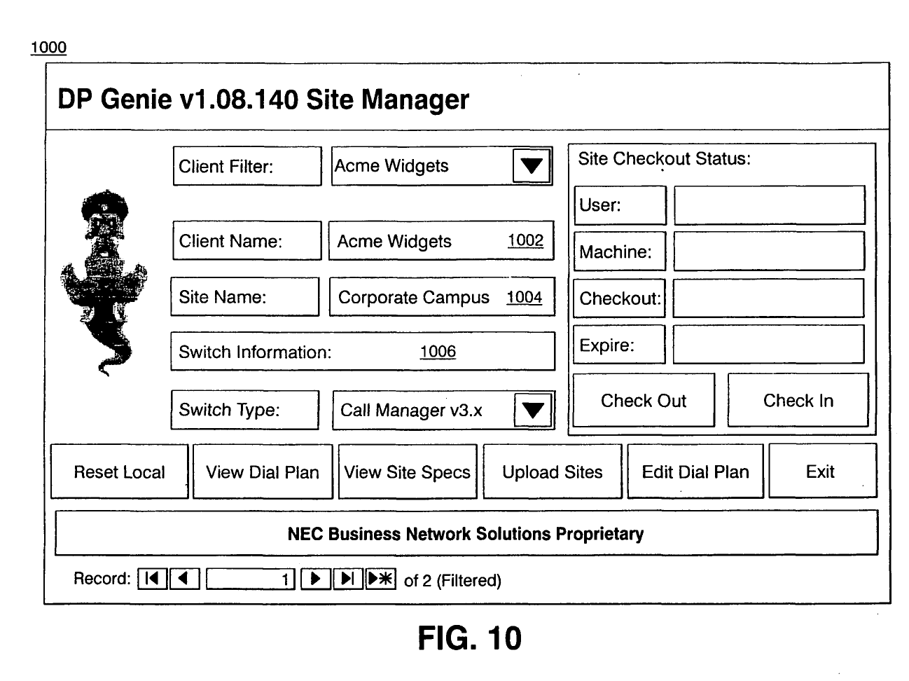

FIG. 10 is an exemplary illustration of a site manger screen display for editing a site (publisher) without a checkout lock according to the present invention. More specifically, the site manager allows users to add and edit a site (publisher) for a given client (e.g., enterprise) without checking out the site. Without checking out the site, the user has no ability to edit the client or site. At input field 1002, the user (i.e., SDC) enters the client name to add or edit. At input field 1004, the user specified the site name for that client. At input filed 1006, the user specifies Cisco's CallManager voice-over-IP (VoIP) telephony switch.

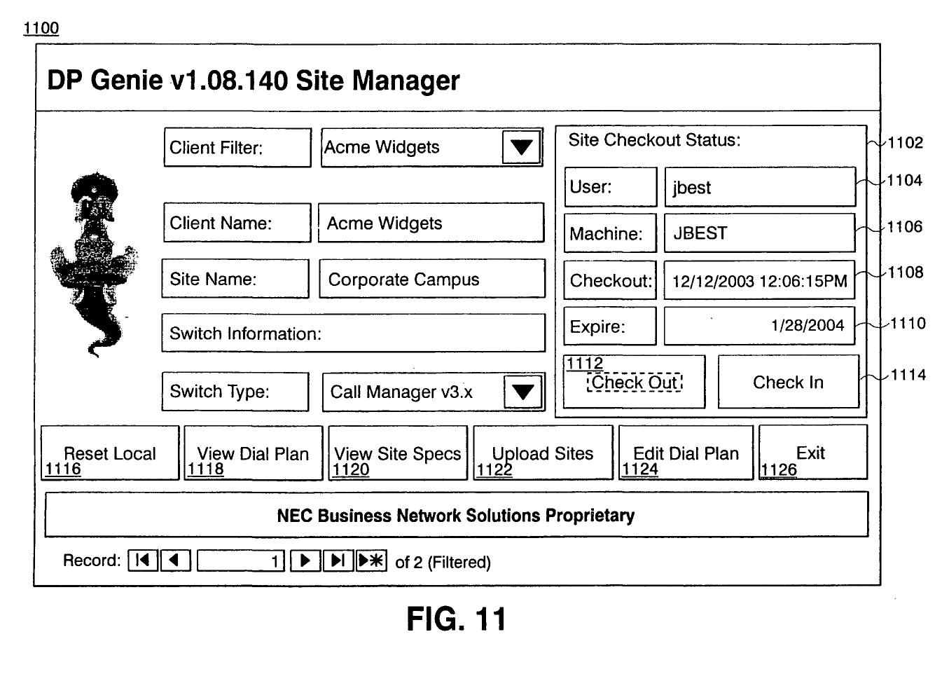

FIG. 11 is an exemplary illustration of a site manger screen display for editing a site (publisher) with checkout lock according to the present invention. More specifically, the site manager enables the user to place a checkout lock on a given site so that the user is the exclusive user allowed to edit that site until the site is checked back into the DPG SQL server. At 1102, the site manger displays the site checkout status. When the user selects the checkout button 1112, the NT domain username 1104, the machine name 1106, the checkout date 1108 and the expiration date 1110 fields are filled in by the DPG client. The checkout places a lock on the client/site data on the DPG SQL server, so that the user is the only user that is enabled to modify the site. The checkout further downloads all the essential data for the site to the local Access 2000 database of the DPG client. The checkout lock is associated to the user 1104 and the machine 1106 specified with an expiration date 1110. The check out status is displayed in field 1108. Failure to act on the part of the user will cause the site to be automatically released from checkout. Check in button 1114 allows the user to check in the site that was checked out from the DPG SQL server. The check in automatically updates the data in the server with the modified data on the client and makes that data available to other users. The reset local 1118 enables the user to release local DPG client data that the user may currently have, and to update the DPG client with the most current versions. The view dial plan enables the user to bring display a dial plan report so that it may be printed for client signature or for progress review. A portion of a sample dial plan report for clients signature is depicted in FIG. 15. The view site specs button displays a summary of the site details, which includes the number and type of VoIP telephones, calling search spaces (CSS), import templates and locations that need to be configured on Cisco's CallManager server prior to importing the dial plan. The upload sites 1122 sends a newly added site or sites to the central DPG SQL server so that the sites are available for checkout to all authorized users. The edit dial plan button 1124 enables the user to modify the specific telephone extensions and other options within the dial plan for the site of a client. The exit button 1126 exits the site manager.

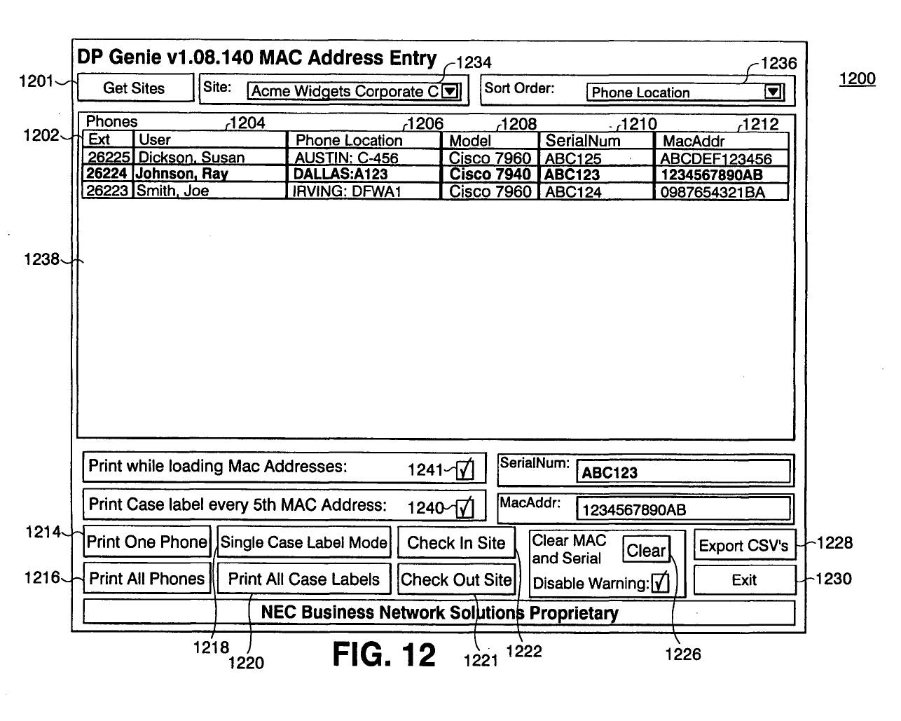

FIG. 12 is an exemplary illustration of a MAC address entry screen display according to the present invention. More specifically, the CDS engineer 306 will associate the physical VoIP telephones 108a-108c in FIG. 1 to the calling plan entries for a site 1234. Button 1201 enables CDS engineer 306 to obtain available sites. Display part 1238 in the MAC address entry screen display depicts a list of entries. The list comprises 6 columns: phones 1202; user 1204, phone location 1206, model 1208; serial number 1210; and MAC address 1212. A drop down list 1236 allows the user to sort the list of entries by the any column 1202-1212 in the list. This feature provides for grouping of VoIP telephones, so that scanned and labeled telephones are grouped according to an attribute such as phone location or phone type, allowing for streamlining/logistics of shipping and placement. The list of entries displayed in display part 1238 is sorted by the model 1208 of the VoIP telephone. The assignment of the serial number 1210 and MAC address 1212 is accomplished by selecting extension 1202 to assign. For example, extension “7908” for Howard Munding is selected for assignment. Once selected, the user enters the serial number 1210 and the MAC address 1212 of the physical VoIP telephone. The MAC address entry screen display is also enabled for allowing an authorized user to scan each VoIP telephone's MAC address and serial number bar code without using the mouse or keyboard. DPG validates that each MAC address is uniquely assigned to a VoIP telephone. After each VoIP telephone's serial number and MAC address are entered or scanned, labels may be printed that contains all the information needed to get that device to the specified user's desk, i.e., phone labels (FIG. 13) and case labels (FIG. 14). If checkbox 1241 is selected phone labels will be printed as MAC addresses are loaded. If checkbox 1240 is selected, every fifth scan will generate a case label that can be placed on the outside of a box that contains five individual VoIP telephones, to help in routing that case of VoIP telephones to the correct area at the client site. To reprint any single phone label, the phone label may be generated out of sequence by selecting the print one phone label button 1214. To reprint all phones labels button 1216 is selected. Case labels for multiple telephones 108a-108c may be generated via buttons 1218 and 1220. Buttons 1221 and 1222 check in a site and check out a site, respectively. Button 1226 disassociates a MAC address and a serial number from the selected entry in the list. Export CSVs button 1228 generates a comma-delimited (CSV) input file for each list entry that will be used by the CDS engineer to import into Cisco's CallManager via Cisco's Bulk Administration Tool, so that the publisher server 102 will be pre-configured for the site prior to delivery for implementation. Each of the CSV files is automatically created and named as a combination of VoIP phone type, number of extensions per phone and a calling search space (CSS) via an underscore. This facilitates Cisco's Bulk Administration Tool because each CSV file is individually imported into the Cisco's CallManager via Cisco's Bulk Administration Tool by phone type, number of extensions and CSS.

FIG. 13 is an exemplary illustration of a phone label generated in FIG. 12 according to the present invention. The phone label comprises the following information for aiding in delivery of the VoIP telephone 108: user 1302, client/site 1304, desk/office 1306, location 1308, model 1310, extension 1312, MAC address 1314 and serial number 1316.

FIG. 14 is an exemplary illustration of a case label for five VoIP telephones generated in FIG. 12 according to the present invention. The case label comprises the following information for aiding in delivery of the case that includes a plurality of VoIP telephone 108a-108c: user 1302, client/site 1304, location 1308, model 1310, extension 1312, MAC address 1314 and serial number 1316.

FIG. 15 is an exemplary illustration 1500 of a portion of a sample dial plan report for a site for a client's signature, according to the present invention. All information identifying each user and associated telephone information is listed in the dial plan report as shown in FIG. 15.

FIG. 15a is an exemplary illustration of a site definition report 1500a. This report details the parameters that need to be set within the Bulk Administration Tool (BAT). The report also allows for validation of VoIP phone quantity and type, locations, and calling search spaces.

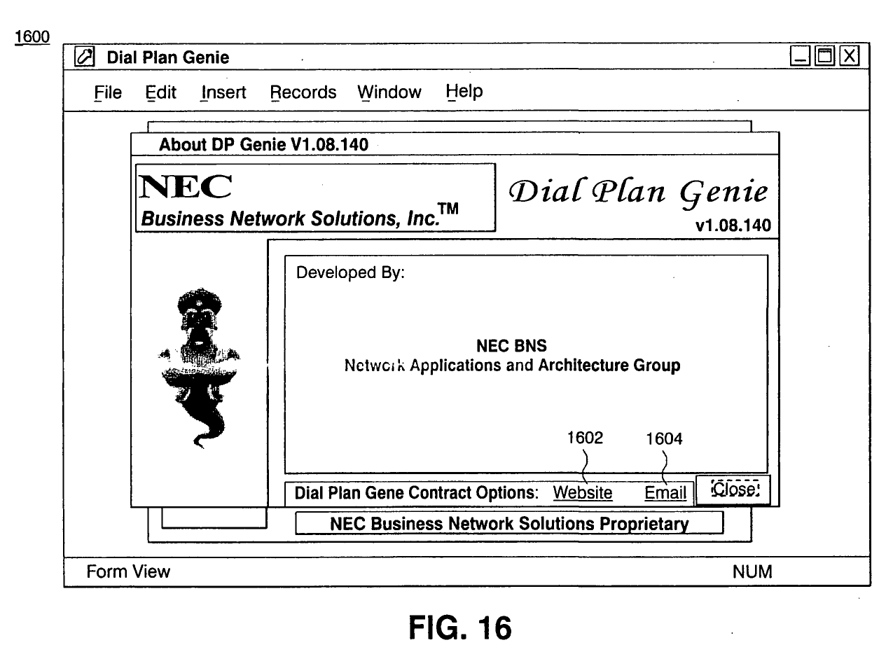

FIG. 16 is an exemplary illustration of support information screen display for the DPG software application according to the present invention. The screen display provides website link 1602 and email link 1604 for obtaining technical support for the DPG software application.

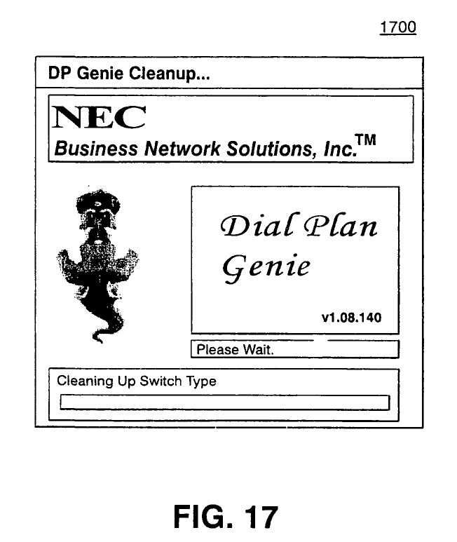

FIG. 17 is an exemplary illustration of a logout screen display when the Dial Plan Genie (DPG) software application is closed by a user according to the present invention. On closing the application, all connections to the local DPG client database are cleaned up and prepared for next use.

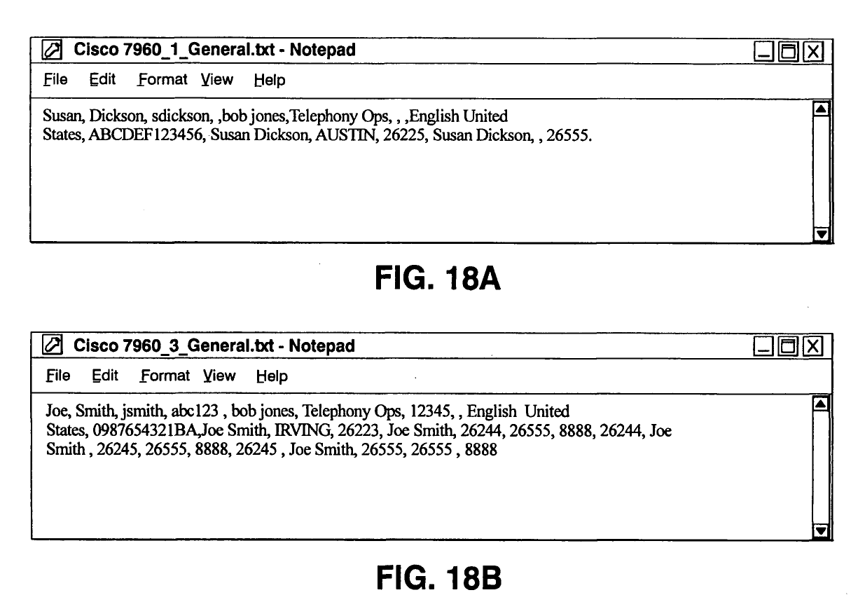

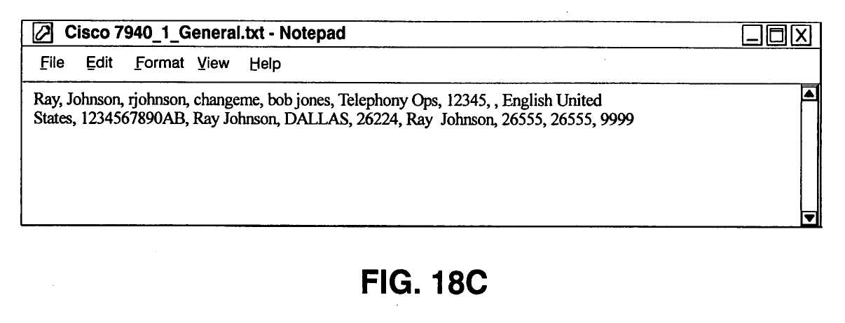

FIG. 18a-c are exemplary illustrations of CSV files generated by DPG software application for use by the Cisco's Bulk Administration Tool to configure the CallManager for voice-over-IP (VoIP) telephony for the enterprise, according to the present invention.

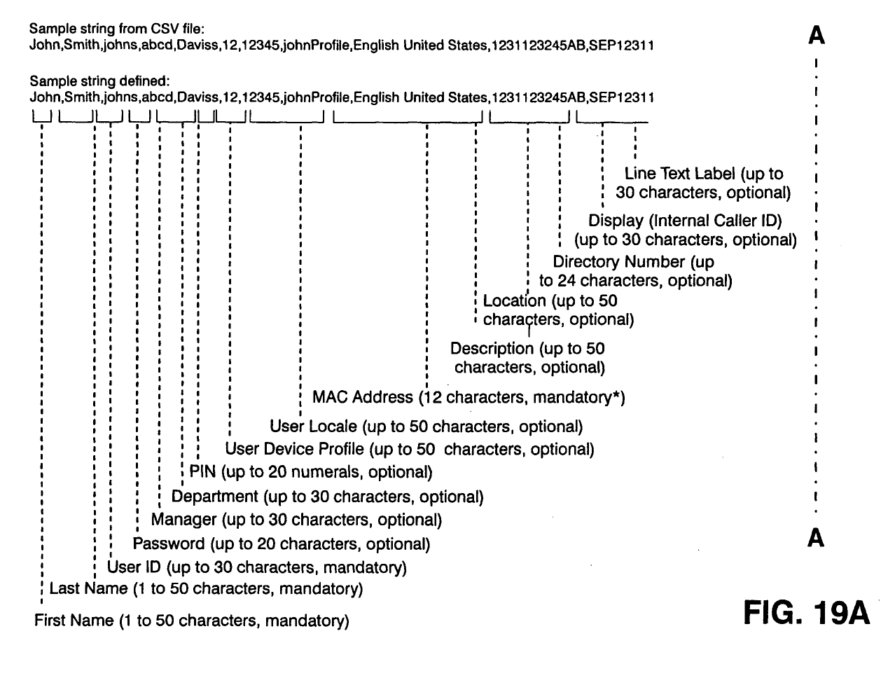

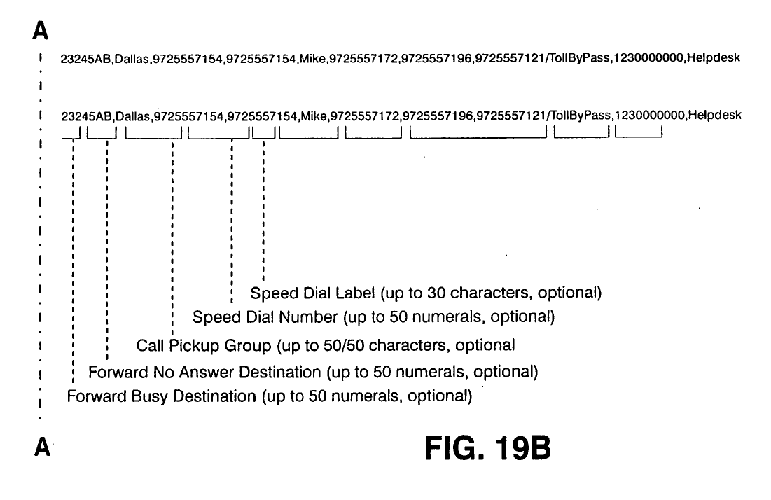

FIG. 19 is an exemplary illustration of a CSV file generated by DPG software application for use by the Cisco's Bulk Administration Tool to configure the CallManager for voice-over-IP (VoIP) telephony for the enterprise, according to the present invention. In this illustration, the contents of each comma-delimited field are described.

FIG. 20 is an exemplary illustration of a DPG system 2000 that includes the DPG software application, to be used by the Cisco's Bulk Administration Tool to configure the CallManager for voice-over-IP (VoIP) telephony for the enterprise, according to the present invention. In this illustration 2000, a user operating the DPG client 2004 logs into the DPG sever 2002. The user operating the DPG client and using the bar code scanner 2010 is enabled to scan in the VoIP telephone data into the DPG application. The DPG application produces the output folder 2006 that includes one more CSV files 2008 for use in Cisco's Bulk Administration Tool to configure the CallManager for voice-over-IP (VoIP) telephony for the enterprise. The label printer 2012 is used to print labels, which when attached to boxed VoIP telephones, provide logistical information to improve efficiency of the process of assigning a phone to an end user, shipping the VoIP phone, and placing the VoIP phone at an appropriate location.

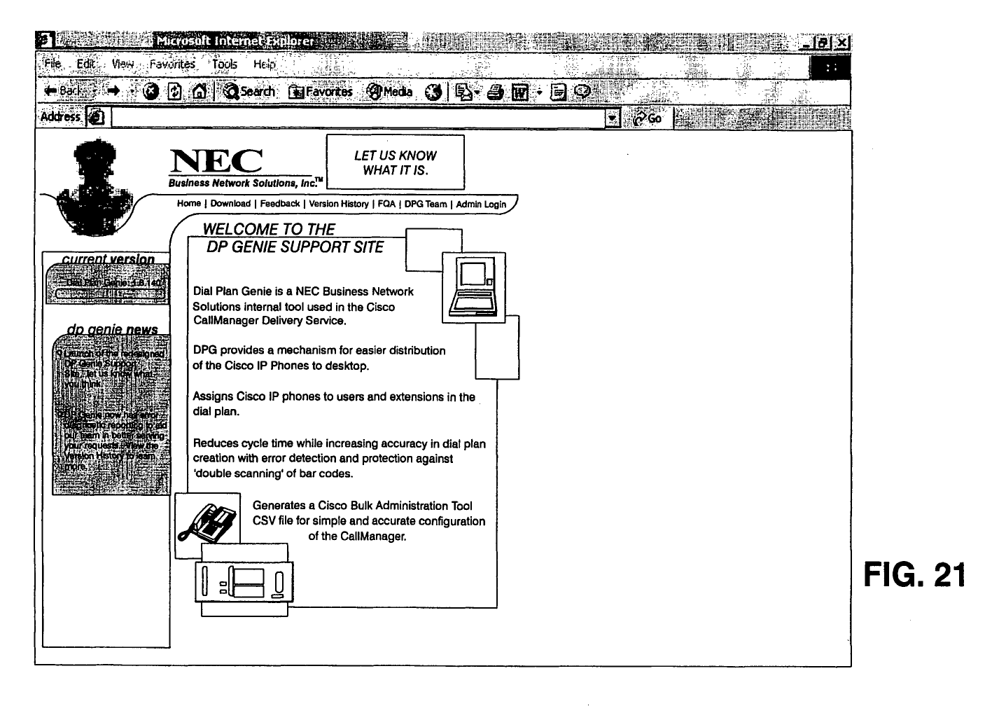

FIG. 21 depicts an exemplary DPG support website for the DPG, having links to download DPG, feedback, version history FAQ, as well as Administrator login.

The foregoing FIGS. 1-18 and associated description exemplify the significant improvements that the present invention (DPG) delivers over the current Cisco tools. More specifically, the present invention streamlines the installation process of Cisco CallManager by providing a single user interface to gather, validate, load, and deploy phones at a customer site. The invention provides for multi-user management, improved accuracy in data collection, relational data modeling, and a collaborative delivery process of VoIP telephony to the enterprise. The new features identified in the figures provide a mechanism to collect user data, assigning phone and phone type to the user, track associated phone throughout the delivery process. Existing tools rely on a Microsoft Excel Spreadsheet that does not assure uniqueness of extension or phone assignment. Furthermore, existing tools do not consider phone serial number or its bar code in its processing. Nor do the existing tools provide a mechanism for indicating phone association to assigned user location. In improving on the existing tools, the present invention automatically produces printed labels, which when attached to boxed VoIP phones provides logistical information to improve efficiency of the process of assigning the phone to an end user, shipping the VoIP phone, and placing the VoIP phone at the appropriate location.

Another improvement provided by the DPG software application over the existing Microsoft Excel Spreadsheet is that the invention automatically prepares input data files for use by the Cisco Bulk Administration Tool, which is an application used to prepare and configure the Cisco CallManager server. Data is organized into comma separated value (CSV) files, which are named by concatenating the VoIP phone type, number of extensions per VoIP phone, and Calling Search Space (CSS) assignment via an underscore. One CSV file is created for each combination of phone type, number of extensions, and CSS on a per site basis by executing a single command. The existing technology relies on the user to prepare and name a Microsoft Excel spreadsheet for each combination of phone type, number of extensions, and Calling Search Space.

Dial Plan Genie is software that provides a mechanism to collect user data, assign phone and phone type to user, and provides the environment to track associated phone throughout the delivery process. This software technology automatically produces printed adhesive labels which when attached to boxed VoIP phone provides logistical information to improve efficiency of the process of assigning the phone to an end user, shipping the VoIP phone, and placing the VoIP phone at the appropriate location. This printing process occurs during the bar code scan process in which IP phone data is collected by the client application by scanning the bar codes for the IP phone's serial number and the IP phones MAC address. The DPG software application operates in the context of the Microsoft SQL for RDBMS and a client application. The DPG software application referred to as the client application has the ability to connect to the Microsoft SQL server for the purpose of placing customer configuration information into the client application as well as placing configuration information that was entered into the client application into the Microsoft SQL server database. This process is referred to in the application as the “Check In” and “Check Out” procedure. While a given customer site is checked out, the site is unavailable to be modified or checked out by anyone else. The process of checking the site back in is the process in which data is transferred from the client application back to the SQL server. The customer site is then available to be checked back in.

The present invention is easily scalable to work on any IP-based private branch exchange (PBX). In addition, the invention reduces the configuration and installation time needed to deploy Cisco's CallManager, allowing the handling of increased engagements.

While the invention has been particularly shown and described with regard to a preferred embodiment thereof, it will be understood by those skilled in the art that the foregoing and other changes in form and details may be made therein without departing from the spirit and scope of the invention.

1. A method for deploying a VoIP telephone system to a location, the VoIP telephone system including a server for managing communication to and from one or more VoIP telephones via a network, the method comprising the step of:
(a) collecting information associated with a dial plan for a plurality of users for a location and updating the dial plan;
(b) automatically generating a plurality of output data files comprising data from the dial plan, each output data file being generated for each unique combination of VoIP telephone type, number of extensions per VoIP telephone and calling search space for the location; and
(c) configuring the server of the VoIP telephone system via each unique output data file.

2. The method for deploying a VoIP telephone system to a location according to claim 1, further comprising a step of installing the VoIP telephone system at the location.

3. The method for deploying a VoIP telephone system to a location according to claim 1, further comprising a step of generating a telephone label for each of the VoIP telephones, the telephone label including data from the dial plan to help deploy an associated VoIP telephone to a proper place in the location.

4. The method for deploying a VoIP telephone system to a location according to claim 1, the method further comprising a step of generating a case label for a plurality of the VoIP telephones, the case label including data from the dial plan to help deploy the plurality of associated VoIP telephones to a proper places in the location.

5. A system for deploying a VoIP telephone system to a location, the VoIP telephone system including a server for managing communication to and from one or more VoIP telephones via a network, the system comprising:
a dial plan server for storing a dial plan;
a client for (i) collecting information associated with a dial plan for the plurality of users for a location and updating the dial plan at the dial plan server; and (ii) automatically generating a plurality of output data files comprising data from the dial plan, each output data file being generated for each unique combination of VoIP telephone type, number of extensions per VoIP telephone and calling search space for the location,
wherein the server of the VoIP telephone system is configured via each unique output data file generated by the client.

6. The system for deploying a VoIP telephone system to a location according to claim 5, further comprising a label printer for generating a telephone label for each of the VoIP telephones, the telephone label including data from the dial plan to help deploy an associated VoIP telephone to a proper place in the location.

7. The system for deploying a VoIP telephone system to a location according to claim 5, further comprising a printer for generating a case label for a plurality of the VoIP telephones, the case label including data from the dial plan to help deploy the plurality of associated VoIP telephones to a proper places in the location.
